(19) United States
(12) Patent Application Publication
(10) Pub. No.: US 2021/0273956 A1
(43) Pub. Date: Sep. 2, 2021

(54) ILLEGAL SIGNAL DETECTION APPARATUS

(71) Applicant: Honda Motor Co., Ltd., Tokyo (JP)

(72) Inventors: Ryoji Nishimoto, Wako-shi (JP); Hirotomi Nemoto, Wako-shi (JP); Kensuke Yamamoto, Wako-shi (JP)

(21) Appl. No.: 17/179,366

(22) Filed: Feb. 18, 2021

(30) Foreign Application Priority Data
Feb. 28, 2020 (JP) 2020-032906

(51) Int. Cl. H04L 29/06

(52) U.S. Cl. CPC H04L 63/1425; H04L 67/12; H04L 63/1458

(57) ABSTRACT

An illegal signal detection apparatus includes: CPU and memory. The CPU is configured to perform: reading normal signal input to communication network at first cycle and abnormal signal input to the communication network at second cycle shorter than the first cycle; counting number of the abnormal signal read in the reading; and determining whether count value corresponding to the number of the abnormal signal read in the reading is equal to or greater than predetermined threshold value when abnormal state in which the abnormal signal is read in predetermined unit time period continuously occurs for predetermined time period. The CPU is configured to perform: the counting including weighting the count value so that the count value increases as compared with the number of the abnormal signal read in the reading with increase in the number of the abnormal signal read in the reading.

### CROSS-REFERENCE TO RELATED APPLICATION

This application is based upon and claims the benefit of priority from Japanese Patent Application No. 2020-032906 filed on Feb. 28, 2020, the content of which is incorporated herein by reference.

### BACKGROUND OF THE INVENTION

### Field of the Invention

This invention relates to an illegal signal detection apparatus for detecting illegal signals input to communication network.

### Description of the Related Art

As a device of this type, a device that detects a denial-of-service (DoS) attack from a device outside a vehicle to an in-vehicle communication network is known (refer to, for example, JP 2016-143963 A). In the device disclosed in JP 2016-143963 A, an amount of data input from the device outside the vehicle to the in-vehicle communication network is detected, and when the amount of data equal to or larger than a threshold set in advance is detected, it is determined that the DoS attack occurs.

However, in the device disclosed in JP 2016-143963 A, it is not possible to determine whether the DoS attack occurs until the amount of data equal to or larger than the threshold set in advance is detected, and it takes time to determine whether the DoS attack occurs.

### SUMMARY OF THE INVENTION

An aspect of the present invention is an illegal signal detection apparatus, including: a CPU and a memory coupled to the CPU. The CPU is configured to perform: reading a normal signal input to a communication network at a first cycle and an abnormal signal input to the communication network at a second cycle shorter than the first cycle; counting a number of the abnormal signal read in the reading; and determining whether a count value corresponding to the number of the abnormal signal read in the reading is equal to or greater than a predetermined threshold value when an abnormal state in which the abnormal signal is read in a predetermined unit time period continuously occurs for a predetermined time period. The CPU is configured to perform: the counting including weighting the count value so that the count value increases as compared with the number of the abnormal signal read in the reading with increase in the number of the abnormal signal read in the reading.

Another aspect of the present invention is an illegal signal detection apparatus, including: a CPU and a memory coupled to the CPU. The CPU is configured to function as: a signal read unit configured to read a normal signal input to a communication network at a first cycle and an abnormal signal input to the communication network at a second cycle shorter than the first cycle; a count unit configured to count a number of the abnormal signal read by the signal read unit; and a determination unit configured to determine whether a count value counted by the count unit is equal to or greater than a predetermined threshold value when an abnormal state in which the abnormal signal is read by the signal read unit in a predetermined unit time period continuously occurs for a predetermined time period. The count unit is configured to weight the count value so that the count value increases as compared with the number of the abnormal signal read by the signal read unit with increase in the number of the abnormal signal read by the signal read unit.

### BRIEF DESCRIPTION OF THE DRAWINGS

The objects, features, and advantages of the present invention will become clearer from the following description of embodiments in relation to the attached drawings, in which:

FIG. 1 is a view schematically illustrating a vehicle to which an illegal signal detection apparatus according to an embodiment of the present invention is applied;

FIG. 2 is a view for explaining normal data signals input to an in-vehicle communication network;

FIG. 3 is a view for explaining a DoS attack to the in-vehicle communication network;

FIG. 4 is a block diagram illustrating a configuration of a substantial part of the illegal signal detection apparatus according to the embodiment of the present invention;

FIG. 5 is a view for explaining a relationship between number of times of reading of abnormal signals and a count value;

FIG. 6 is a view for explaining a relationship between the count value counted by a count unit in FIG. 4 and a detection time period of the DoS attack;

FIG. 7 is a view for explaining a relationship between the number of times of reading of the abnormal signals and a weighting value;

FIG. 8 is a view for explaining an example of the weighting value set by a weighting setting unit in FIG. 4; and

FIG. 9 is a flowchart illustrating an example of processing executed by the illegal signal detection apparatus according to the embodiment of the present invention.

### DETAILED DESCRIPTION OF THE INVENTION

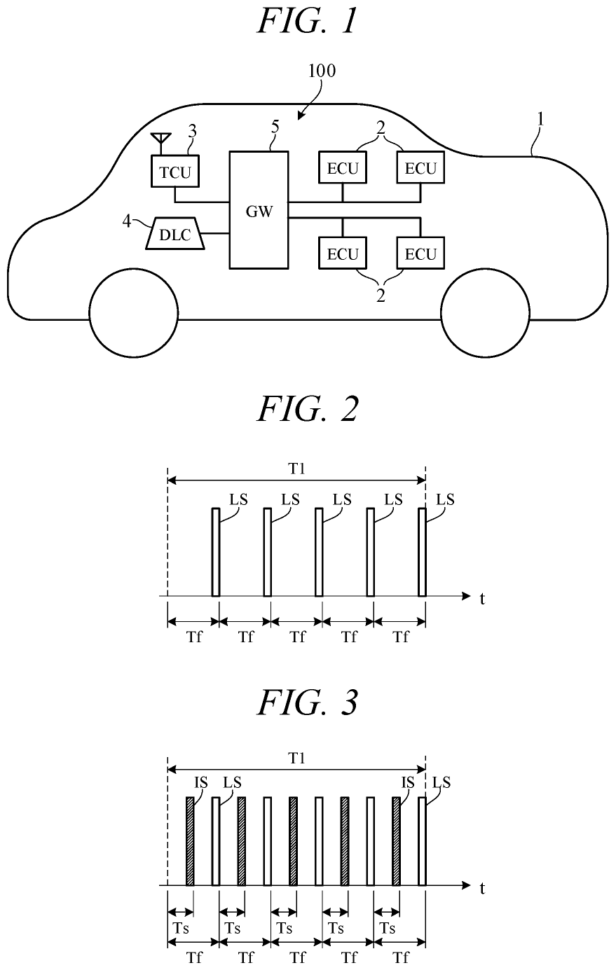

An embodiment of the present invention is hereinafter described with reference to FIGS. 1 to 9. FIG. 1 is a view schematically illustrating a vehicle 1 to which an illegal signal detection apparatus 100 according to the embodiment of the present invention is applied. As illustrated in FIG. 1, the vehicle 1 to which the illegal signal detection apparatus 100 is applied is equipped with a plurality of (four, in an example in FIG. 1) electronic control units (ECUs) 2. The plurality of ECUs 2 includes ECUs having different functions such as ECUs directly affecting an operation of the vehicle 1 such as an engine control ECU, a transmission control ECU, and a steering control ECU, and ECUs for controlling devices that do not directly affect the operation of the vehicle 1 such as an air conditioner and a navigation device.

The ECUs 2 are connected so as to be able to communicate with each other by an in-vehicle communication network such as a controller area network (CAN). Each ECU 2 includes a computer including a CPU, a RAM, a ROM, and other peripheral circuits. Each ECU 2 executes various types of control based on output values from various sensors according to a program stored in a memory in advance.

A telematics control unit (TCU) 3 that performs wireless communication with the outside, and a data link connector (DLC) 4 to which a diagnostic machine that reads a failure code stored in the ECU 2 to perform failure diagnosis of the vehicle 1 or updates the program of the ECU 2 may be connected are further connected to the ECU 2 via the in-vehicle communication network. A gateway 5 is provided between the ECU 2 and the TCU 3 and DLC 4, and the gateway 5 relays communication between the in-vehicle communication network and the outside of the vehicle or communication between a plurality of in-vehicle communication networks.

FIG. 2 is a view for explaining normal data signals (hereinafter also referred to as “normal signals LS”) input to the in-vehicle communication network. The plurality of ECUs 2 performs an arithmetic operation for executing the various types of control according to the program thereof, and mutually transmits/receives data signals including arithmetic results thereof to share, thereby executing cooperative control by the plurality of ECUs 2. The normal signals LS transmitted/received for the cooperative control are input to the in-vehicle communication network at a predetermined cycle Tf. In further detail, as illustrated in FIG. 2, as the normal signals LS, for example, five signals are input to the in-vehicle communication network at the predetermined cycle Tf (for example, 10 ms) in a predetermined unit time period T1 (for example, 50 ms).

FIG. 3 is a view for explaining a DoS attack to the in-vehicle communication network. The in-vehicle communication network is sometimes subjected to an attack in which the transmission/reception of the normal signals LS is hindered by transmission (input) of a large number of illegal data signals by a malicious third party, a so-called denial-of-service (DoS) attack. There is a possibility that each ECU 2 connected to the in-vehicle communication network cannot operate normally when receiving such DoS attack.

As illustrated in FIG. 3, in order to detect occurrence of the DoS attack on the in-vehicle communication network, data signals (hereinafter also referred to as “abnormal signals IS”) input at a cycle Ts shorter than the predetermined cycle Tf are read. In this case, the read abnormal signals IS include the data signals the cycle of which becomes short due to variation in communication that might occur temporarily and the like. Therefore, in order to surely detect the occurrence of the DoS attack, it is necessary that a count value of the number of times of reading of the abnormal signals IS, i.e., the number of the counted abnormal signals, be equal to or larger than a threshold set in advance.

However, when the count value obtained by simply counting the number of times of reading is used, time until determination of the occurrence of the DoS attack becomes longer. Therefore, a load applied to the in-vehicle communication network during this time increases, and there is a possibility that each ECU connected to the in-vehicle communication network cannot operate normally. Therefore, the illegal signal detection apparatus 100 according to the embodiment of the present invention is configured as follows so as to shorten the time required for the determination.

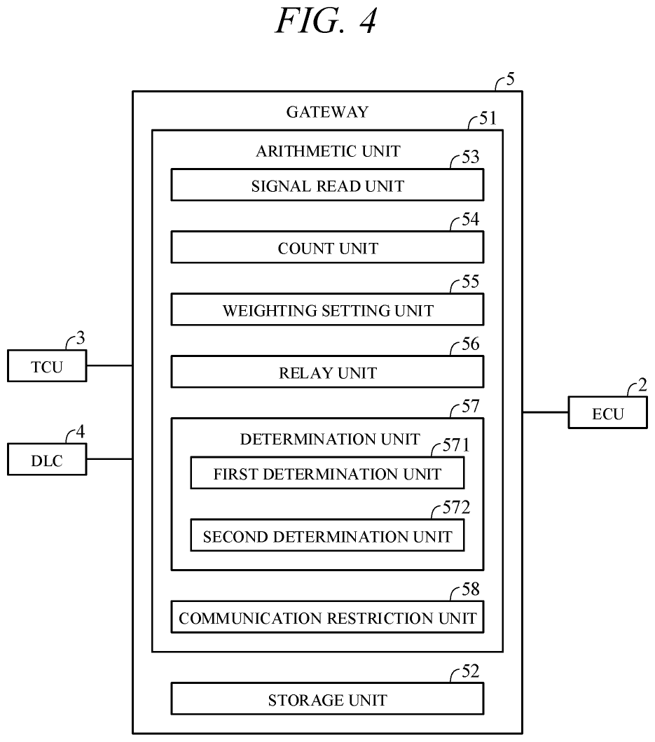

FIG. 4 is a block diagram illustrating a configuration of a substantial part of the illegal signal detection apparatus 100 according to this embodiment. The illegal signal detection apparatus 100 according to this embodiment may be formed of the ECU 2, the gateway 5, or a dedicated device connected to the in-vehicle communication network of the vehicle 1. It is also possible to disperse functions of the illegal signal detection apparatus 100 thereto. In the following, an example in which the illegal signal detection apparatus 100 is formed of the gateway 5 is described.

As illustrated in FIG. 4, the gateway 5 includes a computer including an arithmetic unit 51 such as a CPU, a storage unit 52 such as a ROM, a RAM, and a hard disk, and other peripheral circuits. The arithmetic unit 51 includes a signal read unit 53, a count unit 54, a weighting setting unit 55, a relay unit 56, a determination unit 57, and a communication restriction unit 58 as functional configurations. That is, the CPU of the arithmetic unit 51 serves as the signal read unit 53, the count unit 54, the weighting setting unit 55, the relay unit 56, the determination unit 57, and the communication restriction unit 58.

The signal read unit 53 reads all the data signals input to the gateway 5 via the in-vehicle communication network. The read data signals include the normal signals LS input at the predetermined cycle Tf and the abnormal signals IS input at the cycle Ts shorter than the predetermined cycle Tf. The normal signals LS include the data signals input from outside the vehicle via the TCU 3 and the DLC 4 and the data signals input from each ECU 2 in the vehicle. The abnormal signals IS include not only the data signals the cycle of which becomes shorter than the predetermined cycle Tf due to the variation in communication that might occur temporarily and the like but also illegal data signals such as spoofing input from a falsified ECU or an illegal external device connected to the in-vehicle communication network.

The count unit 54 counts the number of times of reading of the abnormal signals IS read by the signal read unit 53. In further detail, the count unit 54 performs weighted counting of an actual count value (number of times of reading) so that the count value increases as compared with the number of times of reading with an increase in the number of times of reading of the abnormal signals IS read by the signal read unit 53. That is, the count unit 54 performs the weighted counting of the actual count value so that an increase rate of the count value associated with the increase in the number of times of reading becomes larger than an increase rate of the number of times of reading (actual count value). For example, counting to accumulate a value obtained by weighting the actual count value is performed.

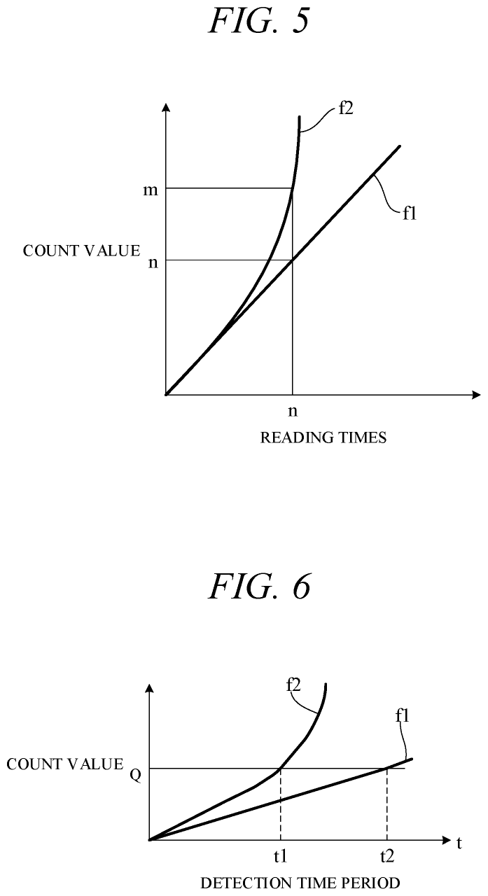

FIG. 5 is a view for explaining a relationship between the number of times of reading of the abnormal signals IS and the count value. A characteristic f1 in FIG. 5 indicates a characteristic of a count value n counted without weighting the actual count value (number of times of reading), and a characteristic f2 indicates a characteristic of a count value m counted while weighting the actual count value (number of times of reading). The count unit 54 weights the actual count value (number of times of reading) so that an increment of the count value added increases each time the abnormal signal IS is read by the signal read unit 53.

As indicated by the characteristic f1 in FIG. 5, in a case of counting without weighting the actual count value, the count value n is always equal to the number of times of reading of the abnormal signals IS (count value n=number of times of reading). Since the count value n in this case increases at the same increase rate as the increase rate of the number of times of reading, the characteristic f1 becomes a straight line having a slope of 1. On the other hand, since it is sufficient that the increase rate of the count value is larger than the increase rate of the number of times of reading, it is sufficient that the characteristic f2 is a straight line or a curve having a slope larger than 1. FIG. 5 illustrates the characteristic f2 of the curve in which the slope continuously increases as the number of times of reading increases, and as indicated by the characteristic f2 in FIG. 5, by making the characteristic of the weighted count value m the curve (or straight line) having the slope larger than 1, the increase rate of the weighted count value m may be made larger than the increase rate of the number of times of reading.

FIG. 6 is a view for explaining a relationship between the count values m and n counted by the count unit 54 and a detection time period t of the DoS attack. The characteristics f1 and f2 in FIG. 6 correspond to the characteristics f1 and f2 in FIG. 5. As illustrated in FIG. 6, since the count value m (characteristic f2) obtained by weighting the actual count value has a higher increase rate associated with the increase in the number of times of reading of the abnormal signals IS than the count value n (characteristic f1) without weighting, the increase rate of the count value also becomes higher with the lapse of the detection time period t in which the number of times of reading increases. Therefore, a time t1 until the count value m (characteristic f2) exceeds a threshold set in advance (set tolerance) Q becomes shorter than a time t2 until the count value n (characteristic f1) without weighting exceeds the threshold value Q (t1<t2), and time until the determination of the occurrence of the DoS attack may be shortened.

The weighting setting unit 55 sets a weighting value α to the actual count value weighted by the count unit 54. The weighting setting unit 55 sets the weighting value α so that the count value m increases as compared with the number of times of reading as the number of times of reading of the abnormal signals IS read by the signal read unit 53 increases. The count unit 54 multiplies or adds the weighting value α set by the weighting setting unit 55 by or to the actual count value n, and counts the count value by or to which the weighting value α is multiplied or added as the weighted count value m.

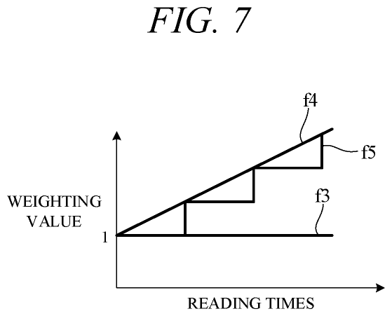

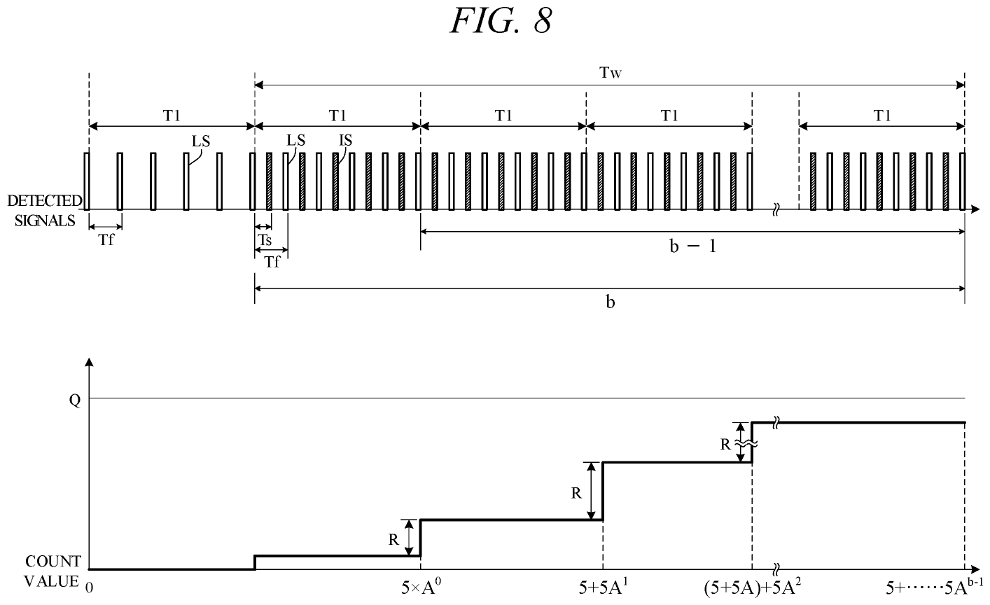

FIG. 7 is a view for explaining a relationship between the number of times of reading of the abnormal signals IS and the weighting value. A characteristic f3 in FIG. 7 indicates a characteristic in a case where the weighting value is 1, that is, the weighting is not performed, and characteristics f4 and f5 indicate characteristics of the weighting value α in a case where the weighting is performed. The weighting value α may be set to continuously increase as indicated by the characteristic f4, or may be set to increase stepwise as indicated by the characteristic f5. In a case of continuous increasing, this may increase linearly (primarily) or in a curved manner (secondarily). In a case of increasing stepwise, an increase rate may be higher as the number of times of reading increases.

FIG. 8 is a view for explaining an example of the weighting value α set by the weighting setting unit 55. As illustrated in FIG. 8, when an abnormal state in which the abnormal signal IS read by the signal read unit 53 is included in the unit time period T1, i.e., at least one abnormal signal IS is read by the signal read unit 53 in the unit time period T1, continuously occurs for a predetermined time period Tw, assuming that the total number of unit time periods T1 in which the abnormal state continuously occurs is b (Tw=T1×b), the number of unit time periods T1 in which the abnormal state continuously occurs is b−1. The weighting setting unit 55 may set, as the weighting value α, a value obtained by making a predetermined value A a base and making the number b−1 of the continuous unit time periods an index, that is, a value A^{b-1} obtained by exponentiating the predetermined value A by the number b−1 of the unit time periods in which the abnormal state continues. By setting such weighting value α, the increase rate (increment R) of the count value m may be made larger than the increase rate of the number of times of reading (FIG. 5). That is, as the number of times of reading increases, the count value m may be made larger than the number of times of reading.

Note that the weighting setting unit 55 may also set, for example, a value A^{b} obtained by exponentiating the predetermined value A by the total number b of the unit time periods in which the abnormal state occurs continuously as the weighting value α. Although the predetermined value A may be set arbitrarily, by setting the predetermined value A to a large value, the increase rate (increment R) of the weighted count value m may be made higher as the number of times of reading increases.

The relay unit 56 relays communication signals (data signals) transmitted/received between the ECU 2 and the TCU 3 and DLC 4. That is, the relay unit 56 transfers (relays) the data signals input from a transmission source to the in-vehicle communication network to be read by the signal read unit 53 to a transmission destination.

When the abnormal state in which the abnormal signal IS read by the signal read unit 53 is included in the unit time period T1 continuously occurs for the predetermined time period Tw, the determination unit 57 determines whether the weighted count value m counted by the count unit 54 is equal to or larger than a predetermined threshold value Q (FIG. 8). That is, it is determined whether the DoS attack occurs.

In further detail, the determination unit 57 includes a first determination unit 571 and a second determination unit 572. The first determination unit 571 determines whether the abnormal state continuously occurs for the predetermined time period Tw. The second determination unit 572 determines whether the count value m counted by the count unit 54 is equal to or larger than the predetermined threshold value Q in a case where the first determination unit 571 determines that the abnormal state continuously occurs. The second determination unit 572 determines whether the count value m is equal to or larger than the threshold value Q each time continuity of the abnormal state is determined by the first determination unit 571. The count unit 54 resets the count value m in a case where it is determined by the first determination unit 571 that the abnormal state does not continue.

Note that the first determination unit 571 and the second determination unit 572 are not necessarily required, and it may be configured to determine the above only by the determination unit 57. The second determination unit 572 may determine whether the count value m is equal to or larger than the threshold value Q in a case where the continuity of the abnormal state determined by the first determination unit 571 is not smaller than a predetermined number of times. For example, it is possible to start determining in a case where it continues three times or more, and thereafter determine each time the continuity is determined, or determine each time it continues twice. With such determination timing, it is possible to efficiently determine.

When it is determined by the determination unit 57 that the DoS attack occurs on the in-vehicle communication network, the communication restriction unit 58 restricts the communication as necessary. For example, relay of the data signals from the transmission source to the transmission destination is prohibited (blocked).

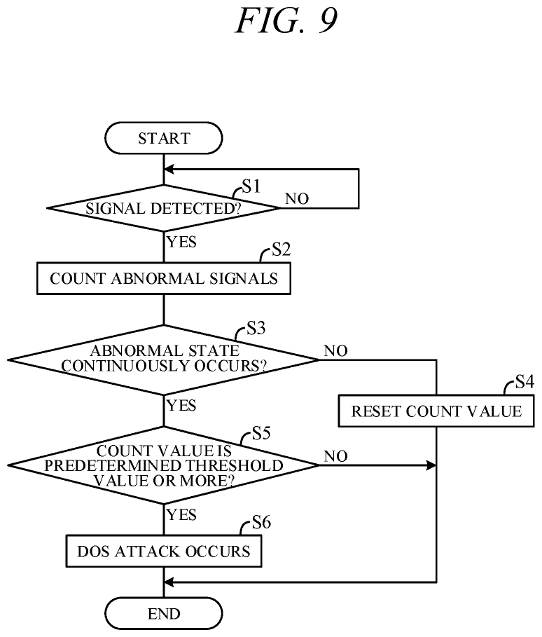

FIG. 9 is a flowchart illustrating an example of processing executed by the illegal signal detection apparatus 100. The processing illustrated in the flowchart starts when the vehicle 1 is activated and the power is supplied to the in-vehicle communication network, and is repeatedly executed at a predetermined cycle, for example.

First, at S1 (S: processing step), it is determined whether new data signals LS and IS are read by a process by the signal read unit 53. S1 is repeated until it is affirmed. When it is affirmed at S1, the procedure shifts to S2, and the number of times of reading of the abnormal signals IS is counted by a process by the count unit 54.

Next, at S3, it is determined whether the abnormal state continuously occurs for a predetermined time by a process by the first determination unit 571. When it is denied at S3, the procedure shifts to S4, and the count value is reset by a process by the count unit 54. On the other hand, when it is affirmed at S3, the procedure shifts to S5, and it is determined whether the count value counted by the count unit 54 is equal to or larger than the predetermined threshold value Q by a process by the second determination unit 572.

When it is denied at S5, the procedure ends, whereas when it is affirmed, the procedure shifts to S6, and it is determined by a process by the determination unit 57 that the DoS attack on the in-vehicle communication network occurs. As a result, when it is determined that the DoS attack on the in-vehicle communication network occurs, it is possible to restrict the communication, for example, prohibit (block) the relay of the data signals by the communication restriction unit 58 as necessary.

A main operation of the gateway (illegal signal detection apparatus 100) 5 according to this embodiment is described more specifically. When a large number of illegal data signals are input from outside the vehicle to the in-vehicle communication network of the vehicle 1 via the TCU 3 (FIG. 1), for example, the gateway 5 (FIG. 1) counts the number of times of reading of the abnormal signals IS (S2 in FIG. 9). At that time, the gateway 5 counts the number of times of reading based on the count value m obtained by weighting the read abnormal signals IS. When the count value reaches the predetermined threshold value Q or larger, it is determined that the in-vehicle communication network is subjected to the DoS attack (S3 to S6 in FIG. 9), and the communication is restricted as necessary. That is, the gateway 5 that monitors the communication signals of an entire in-vehicle communication network may determine whether the DoS attack occurs on the in-vehicle communication network, prohibit the relay of the communication signals as necessary, and restrict the attack on the in-vehicle communication network.

The present embodiment can achieve advantages and effects such as the following:

(1) The gateway 5 includes: the signal read unit 53 configured to read normal signals LS input to the in-vehicle communication network at the predetermined cycle Tf and abnormal signals IS input to the in-vehicle communication network at the cycle Ts shorter than the predetermined cycle Tf; the count unit 54 configured to count the number of the abnormal signals IS read by the signal read unit 53; and the determination unit 57 configured to determine whether the count value m counted by the count unit 54 is equal to or greater than the predetermined threshold value Q when the abnormal state in which the abnormal signal IS is read by the signal read unit 53 in the predetermined unit time period T1 continuously occurs for the predetermined time period Tw (FIG. 4). The count unit 54 is configured to weight the actual count value so that the count value m increases as compared with the number of the abnormal signals IS read by the signal read unit 53 with increase in the number of the abnormal signals IS read by the signal read unit 53 (FIG. 5).

With this configuration, since the actual count value is weighted so that the count value m increases as compared with the number of times of reading as the number of times of reading of the abnormal signals IS increases, it is possible to shorten the time for determining the occurrence of the DoS attack on the in-vehicle communication network. Therefore, it is possible to inhibit the increase in load applied to the in-vehicle communication network until the determination, and to inhibit a state in which the ECU connected to the in-vehicle communication network cannot operate normally. Since the normal signal LS generated during a normal operation has limited duration and is sufficiently shorter than the Dos attack, the normal signal LS stops before the weighted count value m increases, so that this does not reach a threshold and erroneous determination of the normal signal LS as the abnormal signal IS may be inhibited.

(2) The count unit 54 is configured to weight the actual count value so that the increment R of the count value added in each of the predetermined unit time period T1 increases with increase in the number of the abnormal signals IS read by the signal read unit 53. That is, the count unit 54 weights the actual count value so that the increase rate (increment R) of the count value m increases as the number of times of reading increases. As a result, the count value m easily exceeds the predetermined threshold value Q, so that it is possible to further shorten the time required for determining the occurrence of the DoS attack on the in-vehicle communication network.

(3) The gateway 5 further includes: the weighting setting unit 55 configured to set the weighting value α to the count value (FIG. 4). The count unit 54 is configured to weight the actual count value by multiplying the weighting value α set by the weighting setting unit 55 to the actual count value. As a result, since the increase rate (increment R) of the count value m associated with the increase in the number of times of reading becomes further higher, the count value m easily exceeds the predetermined threshold value Q, and the time required for determining the occurrence of the DoS attack on the in-vehicle communication network may be further shortened.

(4) The weighting setting unit 55 is configured to set the value A^{b-1} obtained by exponentiating the predetermined value A by the number b−1 of the unit time period T1 in which the abnormal state continues as the weighting value α when the abnormal state continuously occurs for the predetermined time period Tw. This makes it possible to further increase the increase rate (increment R) of the count value m associated with the increase in the number of times of reading.

In the above-described embodiment, the illegal signal detection apparatus 100 is illustrated as the gateway 5 including the signal read unit 53, the count unit 54, the weighting setting unit 55, and the determination unit 57, but the configuration of the illegal signal detection apparatus is not limited thereto. For example, the signal read unit 53, the count unit 54, the weighting setting unit 55, and the determination unit 57 may be provided on a dedicated device that monitors the communication signals of the entire in-vehicle communication network other than the gateway 5, and they may be dispersed on the gateway 5, the ECU 2, the dedicated device and the like.

In the above-described embodiment, the count unit 54 performs the weighting to multiply the weighting value α set by the weighting setting unit 55 by the actual count value n, but this may be the weighting to add the weighting value set by the weighting setting unit 55 to the actual count value n.

In the above-described embodiment, the in-vehicle communication network using the CAN communication is illustrated as the communication network, but the communication network to which the illegal signal detection apparatus is applied is not limited to this. The communication network may be any network as long as the data signals are input thereto.

The above embodiment can be combined as desired with one or more of the above modifications. The modifications can also be combined with one another.

According to the present invention, it becomes possible to shorten the time required to determine whether the DoS attack to the in-vehicle communication network occurs.

Above, while the present invention has been described with reference to the preferred embodiments thereof, it will be understood, by those skilled in the art, that various changes and modifications may be made thereto without departing from the scope of the appended claims.

What is claimed is:

1. An illegal signal detection apparatus, comprising:
a CPU and a memory coupled to the CPU, wherein
the CPU is configured to perform:
reading a normal signal input to a communication network at a first cycle and an abnormal signal input to the communication network at a second cycle shorter than the first cycle;
counting a number of the abnormal signal read in the reading; and
determining whether a count value corresponding to the number of the abnormal signal read in the reading is equal to or greater than a predetermined threshold value when an abnormal state in which the abnormal signal is read in a predetermined unit time period continuously occurs for a predetermined time period, wherein
the CPU is configured to perform:
the counting including weighting the count value so that the count value increases as compared with the number of the abnormal signal read in the reading with increase in the number of the abnormal signal read in the reading.

2. The illegal signal detection apparatus according to claim 1, wherein
the CPU is configured to perform:
the counting including weighting the count value so that an increment of the count value added in each of the predetermined unit time period increases with increase in the number of the abnormal signal read in the reading.

3. The illegal signal detection apparatus according to claim 1, wherein
the CPU is configured to perform:
setting a weighting value to the count value, wherein
the CPU is configured to perform:
the counting including weighting the count value by multiplying or adding the weighting value set in the setting to the count value.

4. The illegal signal detection apparatus according to claim 3, wherein
the CPU is configured to perform:
the setting including setting a value obtained by exponentiating a predetermined value by a number of the unit time period in which the abnormal state continues as the weighting value when the abnormal state continuously occurs for the predetermined time period.

5. The illegal signal detection apparatus according to claim 1, wherein
the illegal signal is input to the communication network multiple times in the unit time period.

6. An illegal signal detection apparatus, comprising:
a CPU and a memory coupled to the CPU, wherein
the CPU is configured to function as:
a signal read unit configured to read a normal signal input to a communication network at a first cycle and an abnormal signal input to the communication network at a second cycle shorter than the first cycle;
a count unit configured to count a number of the abnormal signal read by the signal read unit; and
a determination unit configured to determine whether a count value counted by the count unit is equal to or greater than a predetermined threshold value when an abnormal state in which the abnormal signal is read by the signal read unit in a predetermined unit time period continuously occurs for a predetermined time period, wherein
the count unit is configured to weight the count value so that the count value increases as compared with the number of the abnormal signal read by the signal read unit with increase in the number of the abnormal signal read by the signal read unit.

7. The illegal signal detection apparatus according to claim 6, wherein
the count unit is configured to weight the count value so that an increment of the count value added in each of the predetermined unit time period increases with increase in the number of the abnormal signal read by the signal read unit.

8. The illegal signal detection apparatus according to claim 6, wherein
the CPU is configured to function as:
a weighting setting unit configured to set a weighting value to the count value, wherein
the count unit is configured to weight the count value by multiplying or adding the weighting value set by the weighting setting unit to the count value.

9. The illegal signal detection apparatus according to claim 8, wherein
the weighting setting unit is configured to set a value obtained by exponentiating a predetermined value by a number of the unit time period in which the abnormal state continues as the weighting value when the abnormal state continuously occurs for the predetermined time period.

10. The illegal signal detection apparatus according to claim 6, wherein
the normal signal is input to the communication network multiple times in the unit time period.
